(19) United States
(12) Patent Application Publication
(10) Pub. No.: US 2022/0176320 A1
(43) Pub. Date: Jun. 9, 2022

(54) METAL ION RECOVERY DEVICE, METAL RECOVERY SYSTEM, AND METAL ION RECOVERY METHOD

(71) Applicant: National Institutes for Quantum Science and Technology, Chiba (JP)

(72) Inventor: Tsuyoshi Hoshino, Kamikita-gun (JP)

(21) Appl. No.: 17/599,060

(22) PCT Filed: Mar. 13, 2020
(86) PCT No.: PCT/JP2020/011148

§ 371 Date: Sep. 28, 2021

(30) Foreign Application Priority Data
Mar. 29, 2019 (JP) 2019-069131

(51) Int. Cl. B01D 61/44; C25C 1/02; C25C 7/00; B01D 69/04; C02F 1/469

(52) U.S. Cl. CPC B01D 61/44; C25C 1/02; C25C 7/00; C02F 2101/10; C02F 1/4693; B01D 2317/04; B01D 69/04

(57) ABSTRACT

What is provided is a metal ion recovery device including a raw solution tank that is configured to store a metal ion containing raw solution including metal ions, a recovery liquid tank that is configured to store a metal ion recovery liquid including metal ions recovered from the metal ion containing raw solution, a cylindrical metal ion selective permeable membrane that partitions off the raw solution tank and the recovery liquid tank and selectively transmits the metal ions, an anode that is electrically connected to a surface of the selective permeable membrane on a side close to the raw solution tank, and a cathode that is electrically connected to a surface of the selective permeable membrane on a side close to the recovery liquid tank.

### TECHNICAL FIELD

The present invention relates to a metal ion recovery device, a metal recovery system, and a metal ion recovery method.

Priority is claimed on Japanese Patent Application No. 2019-069131, filed on Mar. 29, 2019, the content of which is incorporated herein by reference.

### BACKGROUND ART

Lithium ion batteries have been widely used in recent years. Lithium ion batteries are used, for example, as power sources for electric vehicles, portable devices, and the like.

In addition, lithium is used as a raw material for lithium ion batteries. Lithium is also used in the production of tritium as a fuel for nuclear fusion reactors in addition to lithium ion batteries.

For these reasons, in recent years, there has been a rapidly increasing demand for lithium.

Lithium is included in seawater. Therefore, a technique for recovering lithium included in seawater has been studied. Also, a technique for recovering lithium from a used lithium ion battery has been studied.

PTL1 and PTL2 disclose recovery devices for recovering metal ions from a raw solution including metal ions. The recovery devices include a selective permeable membrane formed of a metal ion conductor, a first electrode fixed to a first main surface side of the selective permeable membrane, and a second electrode fixed to a second main surface side of the selective permeable membrane. In the recovery devices disclosed in PTL1 and PTL2, using the structure having the selective permeable membrane, the first electrode, and the second electrode, the raw solution including metal ions and the recovery liquid are separated from each other and the metal ions in the raw solution are moved to the recovery liquid.

### CITATION LIST

### Patent Literature

[PTL 1] Japanese Patent (Granted) Publication No. 6233877

[PTL 2] PCT International Publication No. WO 2017/131051

### SUMMARY OF INVENTION

### Technical Problem

From the viewpoint of effective utilization of resources, it is desired to efficiently recover lithium ions from a lithium ion containing raw solution such as seawater or a waste battery treatment liquid. However, the conventional metal ion recovery devices described in PTL1 and PTL2 have difficulty in improving the metal ion recovery efficiency. That is, the conventional metal ion recovery devices have a structure in which a metal ion containing raw solution and a metal ion recovery liquid are separated from each other using one metal ion conductor (selective permeable membrane). For this reason, it has been difficult to improve the metal ion recovery efficiency per device, and it has been difficult to recover a large amount of metal ions.

The present invention has been made in consideration of the above circumstances and an object thereof is to provide a metal ion recovery device capable of efficiently recovering metal ions. Another object of the present invention is to provide a metal recovery system and a metal ion recovery method using the above metal ion recovery device.

### Solution to Problem

In order to solve the above problems, the present invention employs the following configurations.

[1] A metal ion recovery device including: a raw solution tank that stores a metal ion containing raw solution including metal ions; a recovery liquid tank that stores a metal ion recovery liquid including metal ions recovered from the metal ion containing raw solution; a cylindrical metal ion selective permeable membrane that partitions off the raw solution tank and the recovery liquid tank and selectively transmits the metal ions; an anode that is electrically connected to a surface of the metal ion selective permeable membrane on a side close to the raw solution tank; and a cathode that is electrically connected to a surface of the metal ion selective permeable membrane on a side close to the recovery liquid tank.

[2] The metal ion recovery device according to [1], in which the recovery liquid tank is cylindrical, and the cylindrical recovery liquid tank is arranged in the raw solution tank.

[3] The metal ion recovery device according to [1] or [2], in which two or more cylindrical metal ion selective permeable membranes are provided.

[4] The metal ion recovery device according to any one of [1] to [3], in which the metal ion is a lithium ion.

[5] A metal ion recovery device unit including: a plurality of the metal ion recovery devices according to any one of [1] to [4], in which each of the metal ion recovery devices is connected by a pipe connecting the raw solution tanks and a pipe connecting the recovery liquid tanks.

[6] A metal recovery system including: the metal ion recovery device according to any one of [1] to [4] or the metal ion recovery device unit according to [5]; and a refining device that is connected to the recovery liquid tank of the metal ion recovery device or the metal ion recovery device unit and extracts metal ions included in the metal ion recovery liquid as a compound including the metal ions (as a solid including the corresponding metal elements).

[7] A metal ion recovery method including: by using the metal ion recovery device according to any one of [1] to [4] or the metal ion recovery device unit according to [5], transmitting metal ions included in the metal ion containing raw solution stored in the raw solution tank of the metal ion recovery device or the metal ion recovery device unit through the metal ion selective permeable membrane, and recovering the metal ions with the metal ion recovery liquid stored in the recovery liquid tank.

### Advantageous Effects of Invention

According to the present invention, it is possible to provide a metal ion recovery device capable of improving the recovery efficiency of metal ions (for example, lithium ions) and recovering a large amount of metal ions. Further, according to the present invention, it is possible to provide a metal recovery system and a metal ion recovery method using the metal ion recovery device.

### BRIEF DESCRIPTION OF DRAWINGS

FIG. 1 is a cross-sectional view of an example of a metal ion recovery device according to an embodiment of the present invention.

FIG. 2 is a cross-sectional view of an example of a recovery liquid tank that can be used in the metal ion recovery device according to the embodiment of the present invention and is a view which corresponds to a cross-sectional view taken along line A-A′ of FIG. 1.

FIG. 3 is a cross-sectional view of another example of the recovery liquid tank that can be used in the metal ion recovery device according to the embodiment of the present invention.

FIG. 4 is a cross-sectional view of still another example of the recovery liquid tank that can be used in the metal ion recovery device according to the embodiment of the present invention.

FIG. 5 is a cross-sectional view of still another example of the recovery liquid tank that can be used in the metal ion recovery device according to the embodiment of the present invention.

FIG. 6 is a configuration view of an example of a metal recovery system using a metal ion recovery device according to the embodiment of the present invention.

FIG. 7 is a configuration view of an example of a metal ion recovery device unit according to the embodiment of the present invention.

FIG. 8 is a perspective view of an example of a metal ion recovery cell constituting a single membrane type metal ion recovery device that can be used in the metal ion recovery device unit according to the embodiment of the present invention.

FIG. 9 is an exploded perspective view of the metal ion recovery cell shown in FIG. 8.

FIG. 10 is a perspective view of another example of the metal ion recovery cell constituting the single membrane type metal ion recovery device that can be used in the metal ion recovery device unit according to the embodiment of the present invention.

FIG. 11 is an exploded perspective view of the metal ion recovery cell shown in FIG. 10.

### DESCRIPTION OF EMBODIMENTS

Hereinafter, embodiments of a metal ion recovery device, a metal recovery system, and a metal ion recovery method according to the present invention will be described in detail with reference to the drawings. In addition, the present invention is not limited only to embodiments shown below.

A metal ion recovery device according to this embodiment is a device that recovers metal ions from a metal ion containing raw solution including metal ions. Examples of the metal ions to be recovered include ions of alkali metals, alkaline earth metals, and transition metals. Examples of alkali metals include lithium, sodium, and cesium. Examples of alkaline earth metals include beryllium, magnesium, and calcium. Examples of transition metals include cobalt, nickel, and manganese.

For example, in the embodiment in which lithium ions are recovered as metal ions, the metal ion containing raw solution is a lithium ion containing raw solution including lithium ions.

As the lithium ion containing raw solution, for example, seawater, salt lake brine water, bittern, waste battery treatment liquid, and the like can be used. The lithium concentration in the lithium ion containing raw solution is about 0.17 ppm in the case of the seawater, about 1000 ppm in the case of the salt lake brine water, about 50 to 1000 times of the lithium concentration of the seawater in the case of bittern, and about 2000 to 3000 ppm in the case of the waste battery treatment liquid.

As the lithium ion containing raw solution, it is preferable to use a solution including lithium ions at a lithium concentration of 0.1 mol/L or more. Since the lithium concentration of the salt lake brine water and the waste battery treatment liquid is high, the salt lake brine water and the waste battery treatment liquid are suitable for lithium ion containing raw solutions. In addition, since the bittern can be easily produced from seawater, the bittern is effective as a lithium ion containing raw solution.

As the metal ion containing raw solution (for example, lithium ion containing raw solution), a mineral lithium solution, concentrated seawater obtained from a seawater desalination plant, hot spring water, and the like may be also used, in addition to the seawater, salt lake brine water, bittern, or a waste battery treatment liquid.

The metal ion containing raw solution (for example, lithium ion containing raw solution) may include water, organic solvents, or the like as solvents. The solvent of the metal ion containing raw solution (for example, lithium ion containing raw solution) is preferably water from the viewpoint of burden on the environment.

The metal ion recovery liquid is a liquid for recovering metal ions transmitted through the metal ion selective permeable membrane. The metal ion recovery liquid is not particularly limited as long as the metal ion recovery liquid is a solvent that can dissolve the metal ions. For example, the metal ion recovery liquid may be the same as the solvent of the metal ion containing raw solution.

As the metal ion recovery liquid, for example, water (preferably water with less contamination of metal ions such as pure water and RO water (reverse osmosis membrane permeated water)) is preferable. Alternatively, a solvent effective for the subsequent step of purifying and recovering the metal ions recovered in the recovery liquid may be used.

Suitable examples of the lithium ion recovery liquid in a case of recovering lithium ions as metal ions include water (preferably water with less contamination of metal ions such as pure water and RO water). Alternatively, for example, as the solvent effective for the subsequent step of recovering the lithium ions recovered in the recovery liquid as solid-like lithium, dilute hydrochloric acid may be used.

The metal ion recovery device includes a raw solution tank, a recovery liquid tank, a cylindrical metal ion selective permeable membrane that partitions off the raw solution tank and the recovery liquid tank (hereinafter, also simply referred to as a “selective permeable membrane”), an anode, and a cathode. The raw solution tank is a tank that stores a metal ion containing raw solution. The recovery liquid tank is a tank that stores a metal ion recovery liquid including metal ions recovered from a metal ion containing raw solution.

The selective permeable membrane is constituted of a metal ion conductor (hereinafter, also referred to as a “metal ion conductor”) as a main body.

In the embodiment, the expression “a metal ion conductor as a main body” means that 50% by mass or more of the total mass of the selective permeable membrane is a metal ion conductor.

The percent by mass of the metal ion conductor in the total mass of the selective permeable membrane is preferably 70% by mass or more and more preferably 80% by mass or more to obtain a selective permeable membrane having a high ion conductivity.

The selective permeable membrane may be formed of, for example, a metal ion conductor alone. Further, the selective permeable membrane may be formed of a composite material of a metal ion conductor and a support. Furthermore, the selective permeable membrane may be formed of a composite material of a metal ion conductor and an adsorption layer that contributes to improving the conductivity of metal ions.

The metal ion conductor included in the selective permeable membrane may be formed of a material that can conduct metal ions. The metal ion conductor is preferably formed of a ceramic material that has a crystal structure including a conductive metal element and exhibits ion conductivity due to migration of the metal ions in the crystal. The metal ion conductor is determined according to the kind of metal ion which is transmitted through the selective permeable membrane, that is, the kind of metal ion to be recovered.

The ion conductivity of the metal ion conductor is preferably 10⁻⁴ S cm⁻¹ to 10⁻¹ S cm⁻¹ and more preferably 10⁻³ S cm⁻¹ to 10⁻¹ S cm⁻¹. As the ion conductivity increases, the permeability to the metal ions increases. For example, when the ion conductivity is 10⁻⁴ cm⁻¹ or more, a selective permeable membrane is said to have high permeability to the metal ions. Therefore, the metal ions in the metal ion containing raw solution can be efficiently recovered, and thus this case is preferable. The upper limit of the ion conductivity is not particularly limited but may be, for example, 10⁻¹ S cm⁻¹ or less.

The metal ion conductor used as the selective permeable membrane is determined according to the kind of metal ion which is transmitted through the selective permeable membrane, that is, the kind of metal ion to be recovered. For example, in a case in which the metal ions transmitted through the selective permeable membrane (that is, the metal ions to be recovered) are lithium ions, as the metal ion conductor used as the selective permeable membrane, specifically, lithium ion conductors such as lithium nitride (Li₃N), Li₁₀GeP₂S₁₂, lithium lanthanum titanate: (Liₓ,La_{y})TiO_{z} (here, x=3a−2b, y=2/3−a, z=3−b, 0<a≤1/6, 0≤b≤0.06, x>0) (hereinafter, sometimes referred to as “LLTO”), Li_{1+x+y}Alₓ (Ti,Ge)₂₋ₓSi_{y}P_{3-y}O₁₂ (here, 0≤x≤0.6, 0≤y≤0.6), which is a Li-substituted type Na Super Ionic Conductor (NASICON) type crystal, and the like can be used. All of these lithium ion conductors exhibit a high lithium ion conductivity of 10⁻⁴ S cm⁻¹ or more and are super lithium ion conductors having high selectivity to lithium ions. Accordingly, the metal ion recovery device including the selective permeable membrane having the super lithium ion conductor as a main body can efficiently recover the lithium ions in the raw solution. Among the lithium ion conductors, particularly, lithium lanthanum titanate (LLTO) is preferable. This is because lithium lanthanum titanate has high water resistance and the performance is not easily deteriorated even when immersed in the lithium ion containing raw solution and the lithium ion recovery liquid for a long period of time. Specifically, Li_{0.29}La_{0.57}TiO₃ is preferably used as lithium lanthanum titanate.

Similar to lithium, sodium and cesium, which are alkali metals, may be elements that form metal ion conductors.

In a case in which the metal ions to be recovered are sodium ions, a sodium ion conductor is used as the selective permeable membrane. Examples of the sodium ion conductor include compounds containing sodium such as β alumina, Na₂(BH₄)(NH₂), and Na₃SbS₄−Na₄SnS₄.

In addition, in a case in which the metal ions to be recovered are cesium ions, a cesium ion conductor is used as the selective permeable membrane. As the cesium ion conductor, for example, compounds containing cesium such as (Csₓ,La_{y})TiO_{z} (here, x is 0.29, y is 0.57, and z is 3) are considered to be used.

In a case in which the metal ions to be recovered are ions of alkaline earth metals or transition metals, as in the case of the alkali metal ions, a compound containing the metal element to be recovered can be used as a metal ion conductor.

The selective permeable membrane is preferably a sintered body formed of the metal ion conductor. In a case in which the metal ions to be recovered are lithium ions, particularly, the selective permeable membrane is preferably a sintered body formed of lithium lanthanum titanate (LLTO).

It is preferable that the sintered body of the metal ion conductor is a hard material having excellent water pressure resistance from the viewpoint of excellent durability. In addition, since the sintered body of the metal ion conductor is a porous body in which fine particles formed of the metal ion conductor are bonded (sintered), there are fine irregularities on the surface. Accordingly, when the selective permeable membrane is the sintered body formed of the metal ion conductor, the surface area is large. Therefore, the metal ion recovery device including the selective permeable membrane formed of the sintered body formed of the metal ion conductor is preferable since the contact area between the metal ion containing raw solution and the metal ion conductor is large and the metal ions in the metal ion containing raw solution can be efficiently recovered.

The shape of the selective permeable membrane is cylindrical. The cylindrical selective permeable membrane preferably surrounds one of the raw solution tank and the recovery liquid tank of the metal ion recovery device to form a shape partitioning off the raw solution tank and the recovery liquid tank. The cylindrical shape includes a shape in which the upper end and the lower end are open, a shape in which the lower end is closed (a bottomed cylindrical shape), and a shape in which the upper end and the lower end are closed (a box shape). By using the cylindrical selective permeable membrane, the area of the selective permeable membrane that comes into contact with the metal ion containing raw solution and the metal ion recovery liquid can be increased as compared with a case in which the plate-like selective permeable membrane is used. For this reason, the metal ion recovery efficiency is improved, and a large amount of metal ions can be recovered.

The cylindrical selective permeable membrane may have a cylindrical shape or a rectangular cylindrical. The cylindrical portion of the bottomed cylindrical selective permeable membrane may have a cylindrical shape or a rectangular cylindrical shape. The recovery of the metal ions using a bottomed cylindrical selective permeable membrane can be performed, for example, by a method that the bottomed cylindrical selective permeable membrane is immersed in the metal ion containing raw solution such that the metal ion recovery liquid does not enter through the opening portion at the upper end and the metal ion recovery liquid is injected into inside of the bottomed cylindrical selective permeable membrane. In addition, the recovery of the metal ions can be performed by a method that the bottomed cylindrical selective permeable membrane is immersed in the metal ion recovery liquid such that the metal ion recovery liquid does not enter through the opening portion at the upper end and the metal ion containing raw solution is injected into the inside of the bottomed cylindrical selective permeable membrane. The box-shaped selective permeable membrane may have a cubic shape, a column shape, or a spherical shape. The recovery of the metal ions using the box-shaped selective permeable membrane can be performed, for example, by a method that the box-shaped selective permeable membrane is immersed in the metal ion containing raw solution such that the metal ion recovery liquid is injected into the inside of the box-shaped selective permeable membrane. In addition, the recovery of the metal ions can be performed by a method that the box-shaped selective permeable membrane is immersed in the metal ion recovery liquid such that the metal ion containing raw solution is injected into the inside of the box-shaped selective permeable membrane.

In addition, part of the bottomed cylindrical or box-shaped selective permeable membrane may be provided with a liquid passage port for injecting or discharging the metal ion recovery liquid inside the selective permeable membrane so that the metal ion recovery liquid inside the selective permeable membrane can be replaced. Alternatively, part of the bottomed cylindrical or box-shaped selective permeable membrane is provided with a liquid passage port for injecting or discharging the metal ion containing raw solution inside the selective permeable membrane so that the metal ion containing raw solution inside the selective permeable membrane can be replaced.

The size of the cylindrical selective permeable membrane is not particularly limited. The average thickness of the cylindrical selective permeable membrane is preferably, for example, 0.01 to 20 mm, and more preferably 0.1 to 5 mm. In a case in which the selective permeable membrane is a sintered body of a metal ion conductor, the average thickness is more preferably 0.2 to 1.0 mm.

The opening diameter (the maximum inner diameter, typically the diameter) of the cylindrical selective permeable membrane may be, for example, 0.1 mm or more and is preferably 10 mm or more, more preferably 50 mm or more, and even more preferably 100 mm or more. Although the upper limit of the opening diameter (the maximum inner diameter, typically the diameter) of the cylindrical selective permeable membrane is not limited, the upper limit can be, for example, 5000 mm or less and is preferably 1000 mm or less, and more preferably 500 mm or less. When the opening diameter is 0.1 mm or more, the contact area between the metal ion containing raw solution and the selective permeable membrane is large, the metal ions in the metal ion containing raw solution can be efficiently recovered, and thus this case is preferable. By using a selective permeable membrane having a large opening diameter, the amount of liquid that can pass through the cylinder of the selective permeable membrane can be increased. In order to comparatively achieve both reducing the production cost of the cylindrical selective permeable membrane and ensuring the amount of liquid passing through the selective permeable membrane, it is preferable that the opening diameter of the selective permeable membrane (the maximum inner diameter, typically the diameter) is appropriately set to be within a range of 80 mm or more and 750 mm or less.

The length of the cylindrical selective permeable membrane is not particularly limited, but may be, for example, 10 mm or more and is preferably 100 mm or more. When the length of the selective permeable membrane is 10 mm or more, the contact area between the metal ion containing raw solution and the selective permeable membrane is large, the metal ions in the metal ion containing raw solution can be efficiently recovered, and thus this case is preferable. The upper limit of the length is not particularly limited, but may be, for example, 5000 mm or less, and is typically 4000 mm or less.

It is preferable to set an appropriate combination of the opening diameter and the length of the cylindrical selective permeable membrane in consideration of the amount of liquid passed through the cylinder of the selective permeable membrane (the amount of liquid per unit time) and the contact efficiency between the selective permeable membrane and the metal ion containing raw solution.

Particularly, in a case in which the cylindrical selective permeable membrane is a sintered body of the metal ion conductor, it is preferable that the average thickness is 1.0 to 20.0 mm, the opening diameter is 100 to 500 mm, and the length is 100 to 2000 mm. Such a cylindrical selective permeable membrane can be easily and efficiently produced and is therefore preferable. In addition, in a case in which the selective permeable membrane is formed into such a shape, the amount of the liquid flowing into the cylinder and the contact efficiency of the metal ions with the selective permeable membrane are in a suitable balance, and the metal ions can be efficiently recovered. Thus, this case is preferable.

The anode is electrically connected to the surface of the selective permeable membrane on the raw solution tank side. The anode and the surface of the selective permeable membrane on the raw solution tank side may be electrically connected to each other through a porous current collector. Alternatively, the anode may be arranged in close contact with the surface of the selective permeable membrane on the raw solution tank side to achieve electrical connection. That is, the anode may be integrally formed on the surface of the selective permeable membrane on the raw solution tank side.

As the conductive material for the anode, a conventionally known conductive material can be adopted. As the conductive material for the anode, for example, a material including one or two or more elements selected from Pt, Cu, Au, Ag, C, Fe, W, Mo, Ni, Co, Cr, Ti, Ir, Mn, La, Sr, Al, Pb, Zn, and Rh is preferable and a material including one or two or more elements selected from Pt, Cu, Fe, C, Ag, and Ti is more preferable. Such an anode material may be an alloy, and examples thereof include TiIr and stainless steel (SUS). Particularly, it is more preferable that the anode has Pt, C, or Ti as a main component. This is because the anode formed of the material having these elements as main components has excellent corrosion resistance, for example, even in a case in which corrosive gas such as chlorine gas and/or fluorine gas is generated by recovering the metal ions in the raw solution. The shape of the anode is not particularly limited. The shape of the anode may have a regular pattern such as a cylindrical shape, a plate-like shape, a mesh shape, a rod-like shape, a stripe shape, a dot shape, a lattice shape, or a honeycomb shape, or an irregular pattern.

In a case in which the anode and the selective permeable membrane are electrically connected to each other through a porous current collector, for example, the shape of the anode may be a continuous shape such as a cylindrical shape, a plate-like shape, a mesh shape, a rod-like shape, a lattice shape, or a honeycomb shape. In a case in which the anode is arranged in close contact with the selective permeable membrane to achieve electrical connection, the shape of the anode is not particularly limited and may be any shape. In addition, as the porous current collector for electrically connecting the anode and the selective permeable membrane, for example, a felt-like or sponge-like conductive material can be used. As the conductive material for the porous current collector, those exemplified as the conductive material for the anode can be used. Preferably, a conductive material including C, Ti, Pt, Cu, Fe, and Ag is used.

The cathode is electrically connected to the surface of the selective permeable membrane on the recovery liquid tank side. The cathode may be connected to the surface of the selective permeable membrane on the recovery liquid tank side through a porous current collector. Alternatively, the cathode may be arranged in close contact with the surface of the selective permeable membrane on the recovery liquid tank side to achieve electrical connection. That is, the cathode may be integrally formed on the surface of the selective permeable membrane on the recovery liquid tank side.

As the conductive material for the cathode, those exemplified as the conductive material for the anode can be used. However, the conductive materials forming the anode and the cathode may be the same or different from each other. The shape of the cathode is not particularly limited, and those exemplified as the shape of the anode can be employed. However, the shapes of the anode and the cathode may be the same or different from each other.

As the porous current collector for electrically connecting the cathode and the selective permeable membrane, for example, a felt-like or sponge-like conductive material can be used. As the conductive material for the porous current collector, those exemplified as the conductive material for the anode can be used.

Here, one pair or both pairs of the anode and the selective permeable membrane and the cathode and the selective permeable membrane may be electrically connected through the porous current collector. In addition, one or both of the anode and the cathode may be arranged in close contact with different main surfaces of the selective permeable membrane to achieve electrical connection between these members.

In a case in which the anode or the cathode is arranged in close contact with the selective permeable membrane to achieve electrical connection between the anode or cathode and the selective permeable membrane (in a case in which the electrode is formed integrally with the selective permeable membrane), it is preferable to use a conductive porous membrane as the anode or the cathode. This is because the metal ion containing raw solution or the metal ion recovery liquid can be brought into contact with the selective permeable membrane through the anode or the cathode.

The average pore diameter of the conductive porous membrane used the anode or the cathode is preferably 0.5 to 10 μm. As the average pore diameter of the conductive porous membrane decreases, the contact area of these three components, the selective permeable membrane, the conductive porous membrane, and the metal ion containing raw solution or the metal ion recovery liquid, increases and thus the amount of metal ion permeation can be increased. When the average pore diameter of the conductive porous membrane is 10 μm or less, the effect of increasing the contact area of the three components, the surface of the selective permeable membrane, the conductive porous membrane, and the metal ion containing raw solution or the metal ion recovery liquid, is remarkable. Therefore, the effect of increasing the amount of metal ion permeation is high and preferable. The lower limit value of the average pore diameter of the conductive porous membrane is not particularly limited as long as the selective permeable membrane can be brought into contact with the metal ion containing raw solution or the metal ion recovery liquid through the conductive porous membrane. For example, the average pore diameter of the conductive porous membrane can be set to 0.001 μm or more and may be typically 0.5 μm or more.

The conductive porous membrane can be formed, for example, by applying a paste including a conductive material onto the surface of the selective permeable membrane and firing the paste.

The anode is only required to be arranged so as to cover at least a part of the liquid contact surface (the metal ion containing raw solution contact surface) of the selective permeable membrane. The cathode may be arranged so as to cover at least part of the liquid contact surface (the metal ion recovery liquid contact surface) of the selective permeable membrane. That is, the anode and the cathode are only required to have a shape that covers part of the liquid contact surface of the selective permeable membrane. By using the anode and/or cathode smaller than the liquid contact surface of the selective permeable membrane, it is possible to realize size reduction and/or slimming (thickness reduction) of the metal ion recovery device and to reduce the electrode cost.

The anode and the cathode may be arranged so as to cover the entire liquid contact surface of the selective permeable membrane. The anode or cathode having a shape (outer peripheral shape) that matches the shape (outer peripheral shape) of the liquid contact surface of the selective permeable membrane is a suitable example of the embodiment. The anode or cathode having such a shape is suitable because, for example, in a case in which the anode or cathode is electrically connected to the selective permeable membrane through the porous current collector, the potential of the entire liquid contact surface of the selective permeable membrane is kept almost constant.

Here, the shapes of the anode and the cathode may be the same or different from each other.

The metal ion recovery device of the embodiment can be, for example, a cylindrical selective permeable membrane arrangement type metal ion recovery device in which cylindrical selective permeable membranes are arranged as selective permeable membranes.

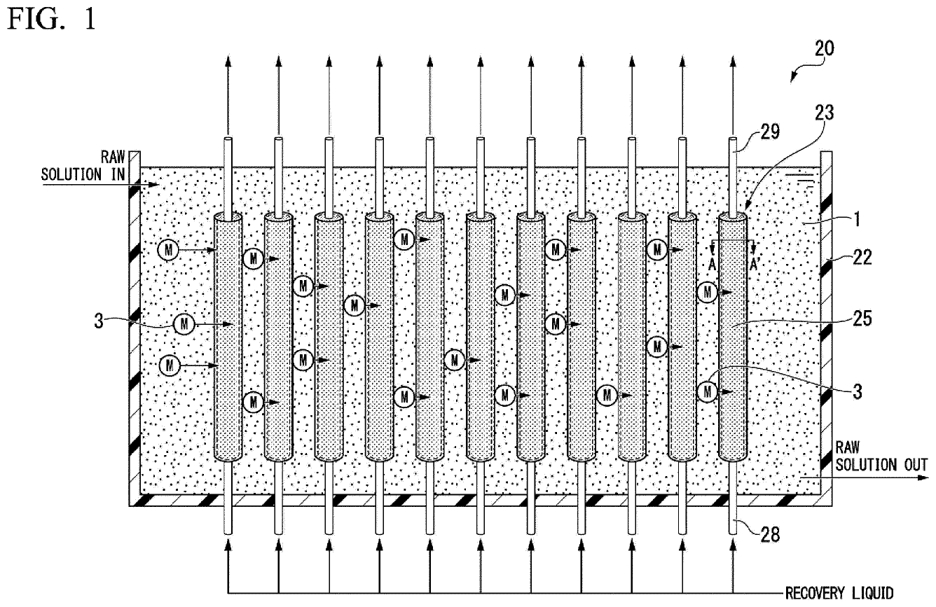

Metal Ion Recovery Device FIG. 1 is a cross-sectional view of an example of a metal ion recovery device according to an embodiment of the present invention.

As shown in FIG. 1, a metal ion recovery device 20 comprises a raw solution tank 22 that stores a metal ion containing raw solution 1 including metal ions, and a recovery liquid tank 23 that stores a metal ion recovery liquid including metal ions recovered from the metal ion containing raw solution 1. In the metal ion recovery device 20 of the embodiment, eleven recovery liquid tanks 23 are arranged in the raw solution tank 22. In the metal ion recovery device 20 of the embodiment, the lower end of the recovery liquid tank 23 is connected to a metal ion recovery liquid introduction pipe 28, and the upper end is connected to a metal ion recovery liquid extraction pipe 29, so that the metal ion recovery liquid flows upward from below in the recovery liquid tank 23. The direction in which the recovery liquid flows in the recovery liquid tank 23 is not limited to this. The upper end of the recovery liquid tank 23 may be connected to the metal ion recovery liquid introduction pipe 28, and the lower end may be connected to the metal ion recovery liquid extraction pipe 29, so that the metal ion recovery liquid flows upward from below in the recovery liquid tank 23.

Next, the recovery liquid tank 23 will be described.

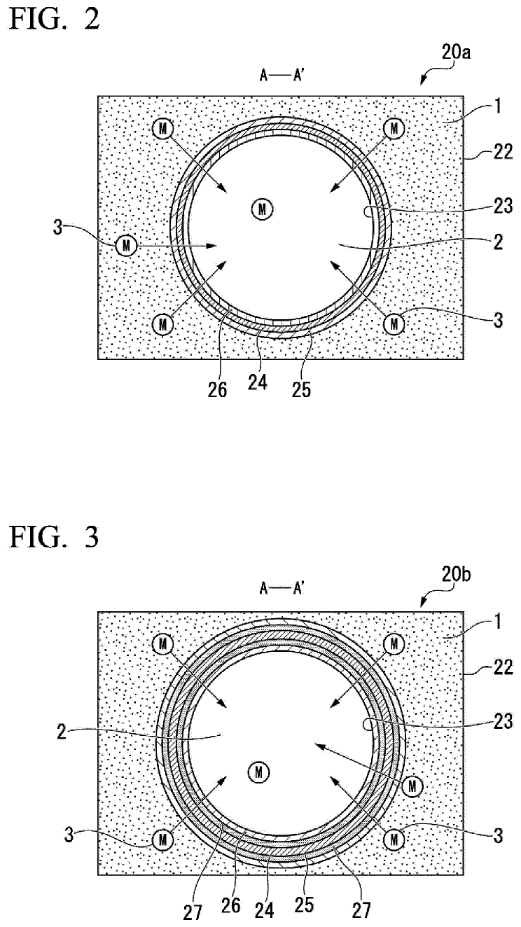

FIG. 2 is a cross-sectional view of an example of a recovery liquid tank that can be used in the metal ion recovery device according to the embodiment of the present invention, and corresponds to a cross-sectional view taken along line A-A′ of FIG. 1.

A recovery liquid tank 23 of a metal ion recovery device 20a shown in FIG. 2 comprises a cylindrical selective permeable membrane 24 that partitions off a raw solution tank 22 and the recovery liquid tank 23 and selectively transmits metal ions, an anode 25 that is electrically connected to the surface of the selective permeable membrane 24 on the raw solution tank 22 side, and a cathode 26 that is electrically connected to the surface of the selective permeable membrane 24 on the recovery liquid tank 23 side. The anode 25 is arranged in close contact with the outer surface of the cylindrical selective permeable membrane 24 to achieve electrical connection. The cathode 26 is arranged in close contact with the inner surface of the cylindrical selective permeable membrane 24 to achieve electrical connection. In the embodiment, the recovery liquid tank 23 is a region surrounded by the cylindrical selective permeable membrane 24 (the cathode 26 in FIG. 2) and has a cylindrical shape. Further, both the anode 25 and the cathode 26 are formed of a cylindrical porous membrane, but the shapes of the anode 25 and the cathode 26 are not limited thereto.

The recovery of the metal ions using the metal ion recovery device 20a is performed as follows.

First, the metal ion containing raw solution 1 is supplied to the raw solution tank 22 and the metal ion recovery liquid 2 is supplied to the cylindrical recovery liquid tank 23, respectively. Next, the anode 25 is set to have a positive potential and the cathode 26 is set to have a negative potential. Thus, among the metal ions 3 in the metal ion containing raw solution 1, the metal ions that have reached the anode 25 side of the cylindrical selective permeable membrane 24 are transmitted through the selective permeable membrane 24 by ion conduction from the anode 25 side to the cathode 26 side. Then, the metal ions 3 transmitted through the selective permeable membrane 24 are recovered by the metal ion recovery liquid 2 stored in the recovery liquid tank 23.

At this time, a method of applying a positive potential to the anode 25 and a method of applying a negative potential to the cathode 26 are not particularly limited. From the viewpoint of efficiently applying the potential to each electrode, it is preferable to apply a positive potential to the anode 25 and ground the cathode 26.

In the metal ion recovery device 20a according to the embodiment, the electrodes are arranged such that the surfaces of the selective permeable membranes 24 facing each other have the same polarity (positive and positive, negative and negative). That is, the anodes 25 are arranged such that the surfaces of the selective permeable membranes 24 facing each other with the raw solution tank 22 interposed therebetween have a positive polarity, and the cathodes 26 are arranged such that the surfaces of the selective permeable membranes 24 facing each other with the recovery liquid tank 23 interposed therebetween have a negative polarity.

In the metal ion recovery device 20a, since the selective permeable membrane 24 has a cylindrical shape, the area of the selective permeable membrane 24 that is in contact with the metal ion containing raw solution 1 and the metal ion recovery liquid 2 is large. For this reason, the metal ion recovery efficiency is improved, and a large amount of metal ions can be recovered. Further, in the metal ion recovery device 20a, the porous current collector is not arranged inside the cylindrical selective permeable membrane 24. Since the porous current collector is not used, a wide opening of the recovery liquid tank 23 arranged inside the selective permeable membrane 24 can be secured, and the capacity of the recovery liquid tank 23 can be increased. Since the porous current collector is not provided in the recovery liquid tank 23, the flow rate does not decrease due to the resistance of the porous current collector. For this reason, the flow rate of the metal ion recovery liquid 2 flowing through the recovery liquid tank 23 can be increased.

FIG. 3 is a cross-sectional view of another example of the recovery liquid tank that can be used in the metal ion recovery device according to the embodiment of the present invention and is a view which corresponds to a cross-sectional view taken along line A-A′ of FIG. 1. In the metal ion recovery device 20b shown in FIG. 3, the same members as those of the metal ion recovery device 20a shown in FIG. 2 are denoted by the same reference numerals as those in FIG. 2, and the detailed description thereof will be omitted.

The metal ion recovery device 20b shown in FIG. 3 is different from the metal ion recovery device 20a shown in FIG. 2 in that the anode 25 is electrically connected to the outer surface of the selective permeable membrane 24 through the porous current collector 27 (for example, carbon felt), and the cathode 26 is electrically connected to the inner surface of the selective permeable membrane 24 through the porous current collector 27 (for example, carbon felt). In the metal ion recovery device 20b, the anode 25, the cathode 26, and the porous current collector 27 are all cylindrical porous membranes, but the shapes of the anode 25, the cathode 26, and the porous current collector 27 are not limited thereto.

In the metal ion recovery device 20b, since the selective permeable membrane 24 has a cylindrical shape; and as in the case of the metal ion recovery device 20a, the metal ion recovery efficiency is improved and a large amount of metal ions can be recovered. Further, since the anode 25 is electrically connected to the outer surface of the selective permeable membrane 24 through the porous current collector 27, the electrical connectivity between the anode 25 and the selective permeable membrane 24 is improved. In addition, since the cathode 26 is electrically connected to the inner surface of the selective permeable membrane 24 through the porous current collector 27, the electrical connectivity between the cathode 26 and the selective permeable membrane 24 is improved. By improving the electrical connectivity between the anode 25 and the selective permeable membrane 24 and between the cathode 26 and the selective permeable membrane 24, the utilization efficiency of electric energy is increased, and thus the metal ion recovery efficiency is further improved.

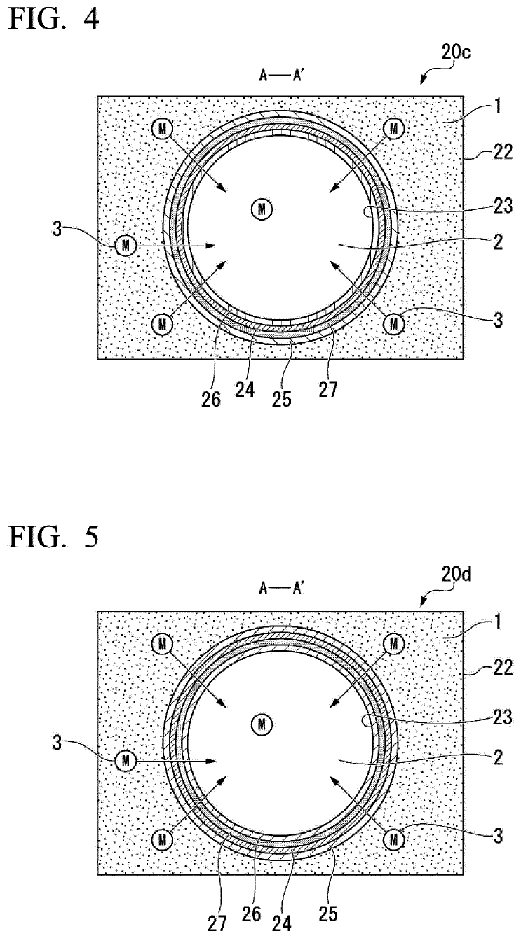

FIG. 4 is a cross-sectional view of still another example of a recovery liquid tank that can be used in the metal ion recovery device according to the embodiment of the present invention, and corresponds to a cross-sectional view taken along line A-A′ of FIG. 1. In the metal ion recovery device 20b shown in FIG. 4, the same members as those of the metal ion recovery device 20a shown in FIG. 2 are denoted by the same reference numerals as in FIG. 2, and the detailed description thereof will be omitted.

A metal ion recovery device 20c shown in FIG. 4 is different from the metal ion recovery device 20a shown in FIG. 2 in that the anode 25 is electrically connected to the outer surface of the selective permeable membrane 24 through the porous current collector 27 (for example, carbon felt).

In the metal ion recovery device 20c, since the selective permeable membrane 24 has a cylindrical shape; and as in the case of the metal ion recovery device 20a, the metal ion recovery efficiency is improved and a large amount of metal ions can be recovered. Further, since the anode 25 is electrically connected to the outer surface of the selective permeable membrane 24 through the porous current collector 27, the electrical connectivity between the anode 25 and the selective permeable membrane 24 is improved.

FIG. 5 is a cross-sectional view of another example of a recovery liquid tank that can be used in the metal ion recovery device according to the embodiment of the present invention, and is a view which corresponds to a cross-sectional view taken along line A-A′ of FIG. 1. In a metal ion recovery device 20d shown in FIG. 5, the same members as those of the metal ion recovery device 20a shown in FIG. 2 are denoted by the same reference numerals as in FIG. 2, and the detailed description thereof will be omitted.

The metal ion recovery device 20d shown in FIG. 5 is different from the metal ion recovery device 20a shown in FIG. 2 in that the cathode 26 is electrically connected to the inner surface of the selective permeable membrane 24 through the porous current collector 27 (for example, carbon felt).

In the metal ion recovery device 20d, since the selective permeable membrane 24 has a cylindrical shape; as in the case of the metal ion recovery device 20a, the metal ion recovery efficiency is improved and a large amount of metal ions can be recovered. In addition, since the cathode 26 is electrically connected to the inner surface of the selective permeable membrane 24 through the porous current collector 27, the electrical connectivity between the cathode 26 and the selective permeable membrane 24 is improved.

The metal ion recovery devices 20, and 20a to 20d according to the above-described embodiment can be formed by, for example, arranging the recovery liquid tanks 23 partitioned off the raw solutions by the selective permeable membrane 24 as it is, in the large raw solution tank 22 such as the sea or a pool. Therefore, the metal ion recovery devices 20, and 20a to 20d (20) of the embodiment are continuous recovery devices having a relatively simple configuration and suitable for recovering a large amount of a target metal (for example, lithium).

However, the metal ion recovery device is not limited to the above embodiments. In the metal ion recovery device 20 shown in FIG. 1, the number of cylindrical selective permeable membranes is 11, but the number of cylindrical selective permeable membranes is not particularly limited. For example, the number of cylindrical selective permeable membranes may be 2 or more, and is preferably 5 or more and more preferably 10 or more. As the number of selective permeable membranes mounted in one metal ion recovery device increases, the amount of metal ions that can be recovered by one metal ion recovery device can be increased. Thus, the number of selective permeable membranes is preferably, for example, 100 or more, more preferably 500 or more, and even more preferably 1000 or more. In other words, for example, the number of recovery liquid tanks 23 may be 2 or more, and is preferably 5 or more and even more preferably 10 or more. From the viewpoint of increasing the amount of metal ions that can be recovered by one metal ion recovery device, for example, the number is preferably 100 or more, more preferably 500 or more, and even more preferably 1000 or more. The number of cylindrical selective permeable membranes, typically, the number of recovery liquid tanks 23 is usually 2 or more, but may be 1.

In addition, for example, in the metal ion recovery devices 20 and 20a to 20d, a region surrounded by the cylindrical selective permeable membrane 24 is defined as the recovery liquid tank 23, and a region outside the cylindrical selective permeable membrane 24 is defined as the raw solution tank 22. However, the region surrounded by the cylindrical selective permeable membrane 24 may be defined as the raw solution tank 22, and the region outside the cylindrical selective permeable membrane 24 may be defined as the recovery liquid tank 23. In this case, the anode 25 is arranged on the inner surface of the selective permeable membrane 24, and the cathode 26 is arranged on the outer surface of the selective permeable membrane 24.

Metal Recovery System

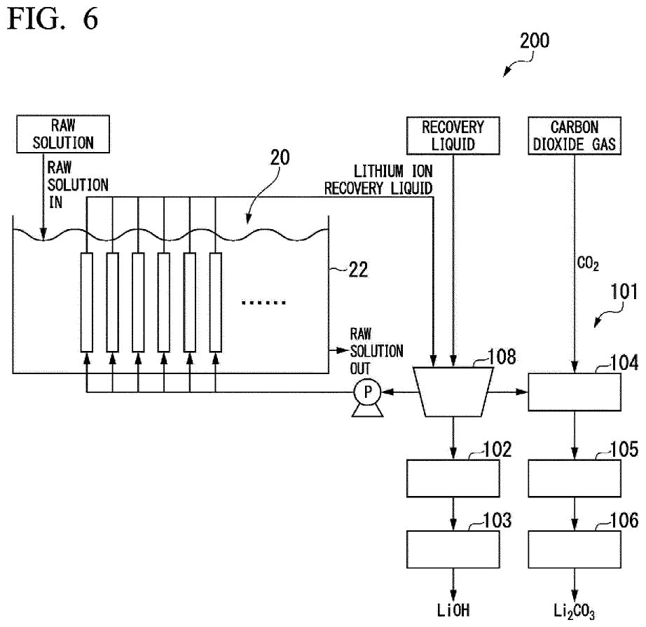

FIG. 6 is a configuration view of an example of a metal recovery system using a metal ion recovery device according to the embodiment of the present invention. Hereinafter, a case in which the metal to be recovered is lithium will be described as an example.

A lithium recovery system 200 shown in FIG. 6 comprises a metal ion recovery device (lithium ion recovery device) 20, and a lithium refining device 101 that extracts metal ions (lithium ions) 3 included in the lithium ion recovery liquid as a compound (solid) including lithium. As the metal ion recovery device, the above-described metal ion recovery devices 20 and 20a to 20d can be used.

Although FIG. 6 illustrates the metal recovery system including the metal ion recovery device as an example, a metal ion recovery device unit to be described later may be provided instead of the metal ion recovery device.

The lithium refining device 101 is not particularly limited as long as the device has a mechanism that extracts metal ions as a solid including lithium. Examples of the solid including lithium include lithium hydroxide, lithium carbonate, and lithium metal.

For example, in the lithium ion recovery liquid, lithium ions exist in the form of lithium hydroxide. Therefore, by providing a drying mechanism for evaporating the solvent of the lithium ion recovery liquid, lithium hydroxide can be refined. In other words, a lithium hydroxide dryer 102 for evaporating the solvent of the lithium ion recovery liquid is an example of the lithium refining device 101.

In addition by supplying carbon dioxide gas to the lithium ion recovery liquid, lithium carbonate can be refined as a precipitate in the lithium ion recovery liquid. That is, a carbon dioxide gas bubbling device 104 for supplying carbon dioxide gas to the lithium ion recovery liquid is an example of the lithium refining device 101. Here, it is preferable that the lithium refining device 101 that produces lithium carbonate comprises a lithium carbonate dryer 105 that dries lithium carbonate precipitated in the lithium recovery liquid.

These lithium refining devices 101 may employ only one kind of mechanism, or may be mounted in combination with a plurality of refining mechanisms. Hereinafter, as shown in FIG. 5, as the lithium refining device 101, a configuration including the lithium hydroxide dryer 102, the carbon dioxide gas bubbling device 104, and the lithium carbonate dryer 105 will be described as an example.

The lithium recovery system 200 shown in FIG. 6 comprises a recovery liquid tank 108 for storing a lithium ion recovery liquid. The raw solution tank 22 of the metal ion recovery device (lithium ion recovery device) 20 is connected to a source of a lithium ion containing raw solution (for example, the sea or a processing plant for used lithium ion batteries). In addition, the lithium recovery system 200 shown in the drawing further comprises a lithium hydroxide packing machine 103 and a lithium carbonate packing machine 106.

The recovery of lithium using the lithium recovery system 200 is performed as follows.

First, a lithium ion recovery liquid is stored in the recovery liquid tank 108.

Next, the lithium ion recovery liquid stored in the recovery liquid tank 108 is supplied to the metal ion recovery device 20. Further, the lithium ion containing raw solution is supplied to the raw solution tank 22 of the metal ion recovery device 20. The metal ion recovery device 20 recovers lithium ions from the lithium ion containing raw solution into the lithium ion recovery liquid by the above method. The raw solution tank 22 discharges the lithium ion containing raw solution when the lithium ion concentration of the lithium ion containing raw solution is lower than a predetermined value. At the same time, the lithium ion containing raw solution is sent from the outside. On the other hand, the lithium ion recovery liquid in which the lithium ions recovered by the metal ion recovery device 20 is stored is sent to the recovery liquid tank 108. The recovery liquid tank 108 sends the lithium ion recovery liquid to the lithium refining device 101 when the lithium ion recovery liquid has a desired lithium ion concentration or higher. At the same time, a new lithium ion recovery liquid is sent to the recovery liquid tank 108 from the outside.

In the lithium refining device 101 shown in FIG. 6, the lithium ions in the lithium ion recovery liquid are extracted as lithium hydroxide (LiOH.H₂O) powder or lithium carbonate (Li₂CO₃) powder.

In a case in which the lithium ions in the lithium ion recovery liquid are extracted as lithium hydroxide powder, for example, the following method is used.

The lithium ion recovery liquid is sent to the lithium hydroxide dryer 102. In the lithium hydroxide dryer 102, the water in the lithium ion recovery liquid is evaporated. Thus, it is possible to easily obtain lithium hydroxide crystals from the lithium ion recovery liquid.

In addition, when the water in the lithium ion recovery liquid is evaporated, it is preferable that the water is evaporated in an environment that the lithium ion recovery liquid does not come into contact with the atmosphere (typically, CO₂ gas in the atmosphere). Thus, it is possible to prevent Li₂CO₃ from being produced by a reaction between the lithium ions in the lithium ion recovery liquid and CO₂ gas in the atmosphere due to contact of the lithium ion recovery liquid and the atmosphere.

Next, the lithium hydroxide powder obtained by the lithium hydroxide dryer 102 is sent to the lithium hydroxide packing machine 103. The lithium hydroxide powder is packed by the lithium hydroxide packing machine 103, and then transported to a place of use.

In a case in which the lithium ions in the lithium ion recovery liquid are extracted as lithium carbonate powder, for example, the following method is used.

The lithium ion recovery liquid is sent to the carbon dioxide gas bubbling device 104. In the carbon dioxide gas bubbling device 104, carbon dioxide gas is supplied to the lithium ion recovery liquid (aqueous lithium hydroxide solution) to transform the lithium ions in the lithium ion recovery liquid to lithium carbonate. Thus, it is possible to easily obtain lithium carbonate crystals from the lithium ion recovery liquid.

Next, a precipitate (lithium carbonate) in the lithium ion recovery liquid is separated and recovered by filtration or decantation. The obtained lithium carbonate is sent to the lithium carbonate dryer 105. Then, in the lithium carbonate dryer 105, the lithium carbonate is dried to obtain lithium carbonate powder.

Next, the lithium carbonate powder obtained in the lithium carbonate dryer 105 is sent to the lithium carbonate packing machine 106. In the lithium carbonate packing machine 106, the lithium carbonate powder is packed and then transported to a place of use.

Since the above-described metal ion recovery device is used as a lithium ion recovery device in the lithium recovery system 200 of the above-described embodiment, there are advantages that the configuration is simple and a large amount of lithium can be recovered, as compared to a case in which a conventional metal ion recovery device is used.

Even when a metal ion recovery device unit described later is provided in the lithium recovery system 200 including the metal ion recovery device 20 instead of the metal ion recovery device 20, the same effect can be obtained. That is, as compared with a case in which the conventional metal ion recovery device is used, there are advantages that the configuration is simple and a large amount of lithium can be recovered.

Metal Ion Recovery Device Unit

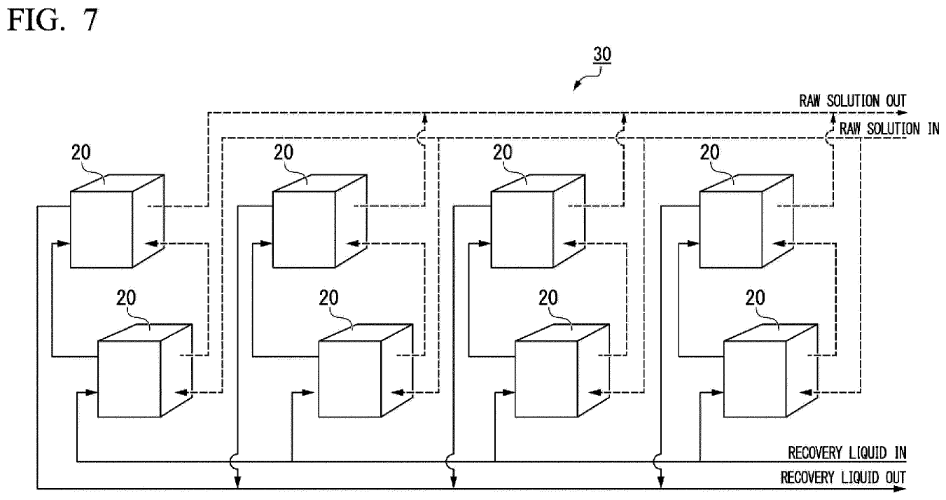

FIG. 7 is a configuration view of an example of a metal ion recovery device unit in which a plurality of metal ion recovery devices according to the embodiment of the present invention are connected to each other. Hereinafter, a case in which the metal ion recovery device in FIG. 7 is the metal ion recovery device 20 shown in FIG. 1 will be described as an example. The metal ion recovery device 20 shown in FIG. 1 has eleven recovery liquid tanks 23. The pipes connecting the metal ion recovery devices 20 are connected to the eleven recovery liquid tanks 23, respectively.

A metal ion recovery device unit 30 shown in FIG. 7 has eight metal ion recovery devices 20. In FIG. 7, two metal ion recovery devices 20 vertically arranged are connected in series such that a metal ion containing raw solution 1 and a metal ion recovery liquid 2 extracted from a lower metal ion recovery device 20 are introduced into an upper metal ion recovery device 20. The two metal ion recovery devices 20 vertically connected in series are connected in parallel to the pipes of the metal ion containing raw solution 1 and the metal ion recovery liquid 2. Here, for convenience, the metal ion recovery device 20 on the upper side (upstream side) and the metal ion recovery device 20 on the lower side (downstream side) will be described, but the present invention is not limited to the configuration in which the actual metal ion recovery devices 20 are vertically arranged. The configuration in which the discharge and introduction of the metal ion containing raw solution 1 and the metal ion recovery liquid 2 are connected so as to be in series or parallel as shown in FIG. 7 can be understood similarly to FIG. 7.

The metal ions 3 are recovered using the metal ion recovery device unit 30 as follows.

First, the metal ion containing raw solution 1 is continuously supplied to a metal ion containing raw solution inlet of the metal ion recovery device 20 on the lower side of the two metal ion recovery devices 20 arranged vertically. Thus, the metal ion containing raw solution 1 is stored in the raw solution tank 22. In addition, the metal ion recovery liquid 2 is continuously supplied to a metal ion recovery liquid inlet of the metal ion recovery device 20 on the lower side of the two metal ion recovery devices 20 arranged vertically. Thus, the metal ion recovery liquid 2 is stored in the recovery liquid tank 23. Next, the anode 25 of each metal ion recovery device 20 is set to have a positive potential and the cathode 26 is set to have a negative potential. Thus, among the metal ions 3 in the metal ion containing raw solution 1 stored in the raw solution tank 22, the metal ions 3 that have reached the anode 25 side of the selective permeable membrane 24 are transmitted through the selective permeable membrane 24 by ion conduction from the anode 25 side to the cathode 26 side. Then, the metal ions 3 that transmit through the selective permeable membrane 24 are recovered in the metal ion recovery liquid 2 stored in the recovery liquid tank 23 (refer to FIG. 1).

Next, the metal ion containing raw solution 1 stored in the raw solution tank 22 of the metal ion recovery device 20 on the lower side is extracted from a metal ion containing raw solution outlet. The extracted metal ion containing raw solution 1 is supplied to the metal ion containing raw solution inlet of the metal ion recovery device 20 on the upper side and stored in the raw solution tank 22. Similarly, the metal ion recovery liquid 2 stored in the recovery liquid tank 23 of the metal ion recovery device 20 on the lower side is extracted from the metal ion recovery liquid outlet. The extracted metal ion recovery liquid 2 is supplied to the metal ion recovery liquid inlet of the metal ion recovery device 20 on the upper side and stored in the recovery liquid tank 23.

Among the metal ions 3 in the metal ion containing raw solution 1 stored in the raw solution tank 22 of the metal ion recovery device 20 on the upper side, the metal ions 3 that have reached the anode 25 side of the selective permeable membrane 24 are transmitted through the selective permeable membrane 24 by ion conduction from the anode 25 side to the cathode 26 side. Then, the metal ions 3 that transmit through the selective permeable membrane 24 are recovered by the metal ion recovery liquid 2 stored in the recovery liquid tank 23.

As described above, by connecting the metal ion recovery devices 20 in series so that the metal ion recovery liquid 2 extracted from a certain metal ion recovery device 20 is introduced into another metal ion recovery device 20, the amount of metal ions 3 recovered in the metal ion recovery liquid 2 per unit capacity can be increased (the metal ion concentration of the metal ion recovery liquid 2 can be increased).

The metal ion recovery device unit 30 of the embodiment configured as described above has a configuration in which a plurality of metal ion recovery devices 20 are mounted. Since one metal ion recovery device unit 30 comprises a large number of selective permeable membranes, the amount of metal ions 3 that can be recovered can be increased. In addition, since the raw solution tanks 22 of the independent metal ion recovery devices 20 are connected to each other by the pipes, and the recovery liquid tanks 23 are connected to each other by the pipes, each metal ion recovery device 20 can be easily replaced.

The metal ion recovery device unit is not limited to the configuration shown in FIG. 7.

For example, all the metal ion recovery devices 20 may be connected in series, or all the metal ion recovery devices 20 may be connected in parallel to the pipes of the metal ion containing raw solution 1 and the metal ion recovery liquid 2.

In addition, the connection modes in which the metal ion containing raw solution 1 and the metal ion recovery liquid 2 are introduced into or discharged from the plurality of metal ion recovery devices 20 may be the same or different connection modes. For example, liquid feeding pipes of the metal ion containing raw solution 1 may be connected in parallel so that all the metal ion containing raw solution 1 discharged from the metal ion recovery device 20 is introduced to the pipe of the metal ion containing raw solution 1. Further, liquid feeding pipes of the metal ion recovery liquid 2 may be connected in series so that the metal ion recovery liquid 2 discharged from the metal ion recovery device 20 is introduced to another metal ion recovery device 20.

Although the metal ion recovery device unit 30 shown in FIG. 7 is described as an example having eight metal ion recovery devices 20, the number of metal ion recovery devices 20 mounted in one metal ion recovery device unit 30 is not particularly limited. The number of metal ion recovery devices 20 may be 2 or more, and is preferably 5 or more and more preferably 10 or more. As the number of metal ion recovery devices 20 mounted in one device (metal ion recovery device unit 30) increases, the amount of metal ions 3 that can be recovered by one device can be increased. For this reason, the number of the metal ion recovery devices 20 is preferably, for example, 100 or more, more preferably 500 or more, and even more preferably 1000 or more.

The configuration of the metal ion recovery device unit is not limited to a configuration in which a plurality of only the above-described cylindrical selective permeable membrane arrangement type metal ion recovery devices are arranged. For example, one or more conventional single membrane type metal ion recovery cells including one selective permeable membrane (or a metal ion recovery device including the same) may be used together with a plurality of the metal ion recovery devices of the embodiment. Alternatively, one or more metal ion recovery devices including a plurality of selective permeable membranes having a non-cylindrical shape, typically a plate-like shape, may be used together with the plurality of metal ion recovery devices of the embodiment. Accordingly, the cylindrical selective permeable membrane arrangement type metal ion recovery device and the metal ion recovery device having another configuration may be connected and applied.

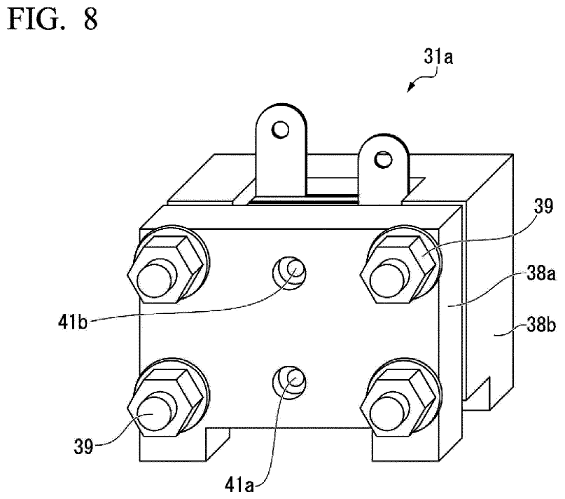

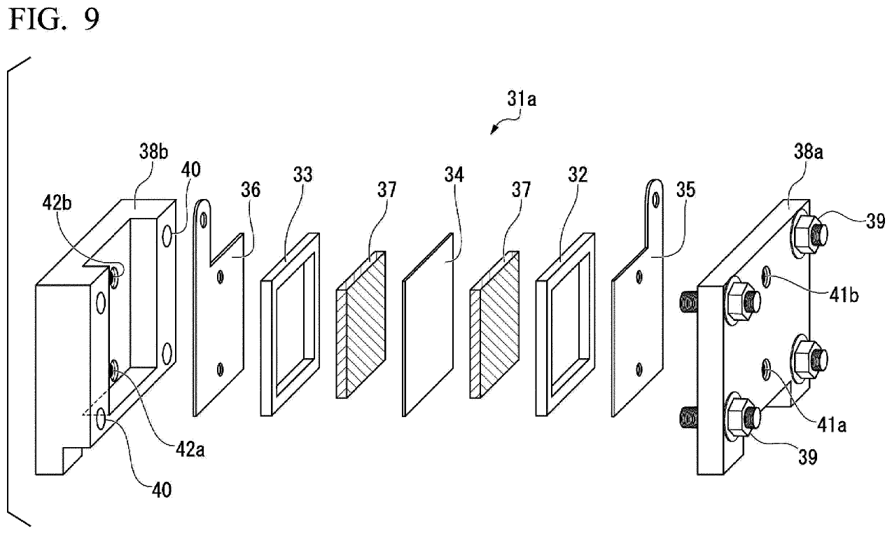

Next, an example of a metal ion recovery cell in which the above-described single membrane type metal ion recovery device (cell type metal ion recovery device) can be used is shown as an example. FIG. 8 is a perspective view of an example of the metal ion recovery cell. FIG. 9 is an exploded perspective view of the metal ion recovery cell shown in FIG. 8. The metal ion recovery cell shown in FIG. 8 is a suitable example of the metal ion recovery device that constitutes the metal ion recovery device unit of the present invention.

A metal ion recovery cell 31a shown in FIGS. 8 and 9 is configured to house a laminate in which a cathode 36, a recovery liquid tank forming frame 33, a selective permeable membrane 34, a raw solution tank forming frame 32, and an anode 35 are laminated in this order from a cell housing portion 38b side between a cell lid portion 38a and a recess portion provided in a cell housing portion 38b. In the recovery liquid tank forming frame 33, a porous current collector 37 is housed for electrically connecting the cathode 36 and the selective permeable membrane 34. In addition, in the raw solution tank forming frame 32, a porous current collector 37 is housed for electrically connecting the anode 35 and the selective permeable membrane 34. The cell lid portion 38a and the cell housing portion 38b are fixed by tightening a bolt 39 penetrating the cell lid portion 38a to a screw hole 40 of the cell housing portion 38b. On the outer surface of the cell lid portion 38a, a metal ion containing raw solution inlet 41a is provided at the center lower part and a metal ion containing raw solution outlet 41b is provided at the center upper part. On the outer surface of the cell housing portion 38b, a metal ion recovery liquid inlet 42a is provided at the center lower part and a metal ion recovery liquid outlet 42b is provided at the center upper part.

In the metal ion recovery cell 31a shown in FIGS. 8 and 9, the metal ion containing raw solution 1 is introduced from the metal ion containing raw solution inlet 41a provided in the lower part of the cell lid portion 38a. In addition, the metal ion recovery liquid 2 is introduced into the metal ion recovery cell 31a from the metal ion recovery liquid inlet 42a provided in the lower part of the cell housing portion 38b. Then, the metal ion containing raw solution 1 is discharged from the metal ion containing raw solution outlet 41b provided in the upper part of the cell lid portion 38a. In addition, the metal ion recovery liquid 2 is discharged from the metal ion recovery liquid outlet 42b provided in the upper part of the cell housing portion 38b.

As described above, the metal ion containing raw solution inlet 41a and the metal ion recovery liquid inlet 42a (hereinafter, these are collectively referred to as “liquid inlets 41a and 42a”) are provided below the metal ion containing raw solution outlet 41b and the metal ion recovery liquid outlet 42b (hereinafter, these are collectively referred to as “liquid outlets 41b and 42b”). As a result, bubbles generated in the metal ion recovery cell 31a (typically, in the raw solution tank 22 and the recovery liquid tank 23) are smoothly discharged out of the cell. According to such a configuration, it is possible to reduce the residual bubbles in the metal ion recovery cell 31a.

In the metal ion recovery cell 31a shown in FIGS. 8 and 9, the configuration in which the liquid inlets 41a and 42a are provided in the lower part of the cell lid portion 38a and the cell housing portion 38b, respectively, and the liquid outlets 41b and 42b are provided in the upper part of the cell lid portion 38a and the cell housing portion 38b, respectively, is described as an example, but the present invention is not limited thereto. For example, the metal ion containing raw solution outlet 41b may be provided in the lower part of the cell lid portion 38a. In addition, for example, the metal ion recovery liquid outlet 42b may be provided in the lower part of the cell housing portion 38b.

In the metal ion recovery cell 31a shown in FIGS. 8 and 9, the configuration in which the liquid inlets 41a and 42a and the liquid outlets 41b and 42b are provided on the wide surfaces of the cell lid portion 38a and the cell housing portion 38b (surfaces in the lamination direction), respectively, is described as an example, but the present invention is not limited thereto. For example, the liquid inlets 41a and 42a and the liquid outlets 41b and 42b may be provided on the narrow surface (side surface) of the cell lid portion 38a and the cell housing portion 38b, respectively.

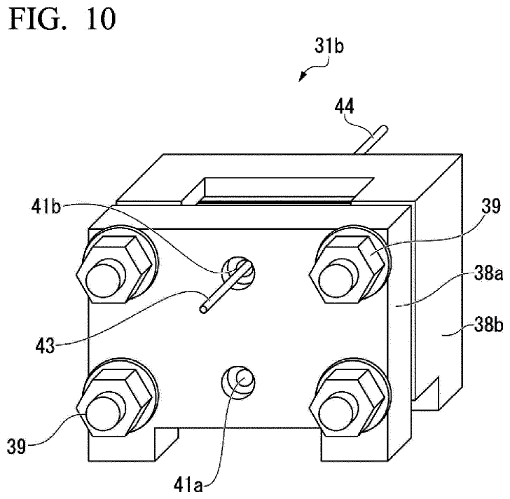

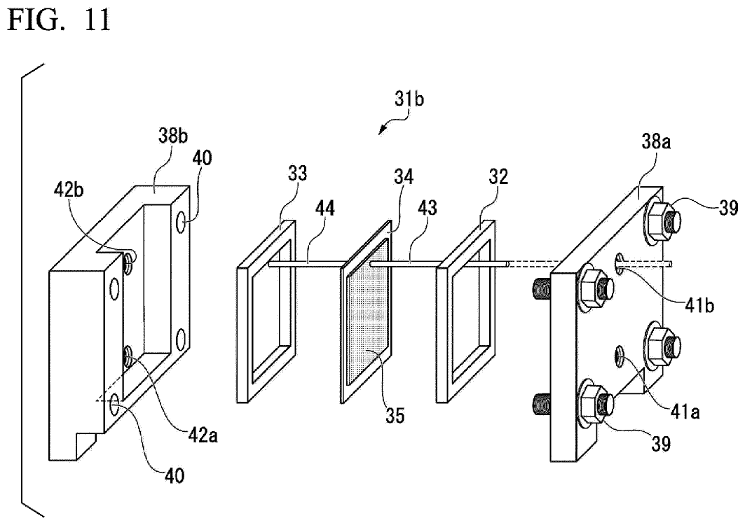

FIG. 10 is a perspective view of another example of the metal ion recovery cell that can be used in the metal ion recovery device unit according to the embodiment of the present invention. FIG. 11 is an exploded perspective view of the metal ion recovery cell shown in FIG. 10. In FIGS. 11 and 12, the same members as those in FIGS. 8 and 9 are denoted by the same reference numerals as those in FIGS. 8 and 9, and the detailed description thereof will be omitted.

In a metal ion recovery cell 31b shown in FIGS. 10 and 11, the anode 35 is arranged in close contact with the surface of the selective permeable membrane 34 on the raw solution tank forming frame 32 side (the anode is formed integrally with the selective permeable membrane) to achieve electrical connection. In addition, the cathode 36 (not shown) is arranged in close contact with the surface of the selective permeable membrane 34 on the recovery liquid tank forming frame 33 side (the cathode is integrally formed with the selective permeable membrane) to achieve electrical connection. From these points, the metal ion recovery cell 31b shown in FIGS. 10 and 11 is different from the metal ion recovery cell 31a shown in FIGS. 8 and 9. Here, in the metal ion recovery cell 31b shown in FIGS. 10 and 11, an anode lead wire 43 connected to the anode 35 is drawn from the metal ion containing raw solution outlet 41b. In addition, a cathode lead wire 44 connected to the cathode is drawn from the metal ion recovery liquid outlet 42b.

In the metal ion recovery cell 31b shown in FIGS. 10 and 11, a porous current collector is not housed in the raw solution tank forming frame 32 and the recovery liquid tank forming frame 33. Therefore, the raw solution tank forming frame 32 and the recovery liquid tank forming frame 33 can be made slim. Further, the flow rate of the metal ion containing raw solution 1 flowing in the raw solution tank forming frame 32 and the flow rate of the metal ion recovery liquid 2 flowing in the recovery liquid tank forming frame 33 can be increased. As the number of metal ions 3 that come into contact with the selective permeable membrane 34 per unit time increases, that is, the flow rate of the metal ion containing raw solution 1 flowing in the raw solution tank forming frame 32 increases, the amount of recovered metal ions tends to increase. Accordingly, the metal ion recovery cell 31b of the embodiment can be made slim and can recover a large amount of metal ions 3.

### REFERENCE SIGNS LIST

1: metal ion containing raw solution
2: metal ion recovery liquid
3: metal ion
20, 20a, 20b, 20c, 20d: metal ion recovery device
22: raw solution tank
23: recovery liquid tank
24: selective permeable membrane
25: anode
26: cathode
27: porous current collector
28: metal ion recovery liquid introduction pipe
29: metal ion recovery liquid extraction pipe
30: metal ion recovery device unit
31a, 31b: metal ion recovery cell
32: raw solution tank forming frame
33: recovery liquid tank forming frame
34: selective permeable membrane
35: anode
36: cathode
37: porous current collector
38a: cell lid portion
38b: cell housing portion
39: bolt
40: screw hole
41a: metal ion containing raw solution inlet
41b: metal ion containing raw solution outlet
42a: metal ion recovery liquid inlet
42b: metal ion recovery liquid outlet
43: anode lead wire
44: cathode lead wire
200: lithium recovery system
101: lithium refining device
102: lithium hydroxide dryer
103: lithium hydroxide packing machine
104: carbon dioxide gas bubbling device
105: lithium carbonate dryer
106: lithium carbonate packing machine
108: recovery liquid tank

1. A metal ion recovery device comprising:
a raw solution tank that is configured to store a metal ion containing raw solution including metal ions;
a recovery liquid tank that is configured to store a metal ion recovery liquid including metal ions recovered from the metal ion containing raw solution;
a cylindrical metal ion selective permeable membrane that partitions off the raw solution tank and the recovery liquid tank and selectively transmits the metal ions;
an anode that is electrically connected to a surface of the metal ion selective permeable membrane on a side close to the raw solution tank; and
a cathode that is electrically connected to a surface of the metal ion selective permeable membrane on a side close to the recovery liquid tank.

2. The metal ion recovery device according to claim 1,
wherein the recovery liquid tank is cylindrical, and the cylindrical recovery liquid tank is arranged in the raw solution tank.

3. The metal ion recovery device according to claim 1,
wherein two or more cylindrical metal ion selective permeable membranes are provided.

4. The metal ion recovery device according to claim 1,
wherein the metal ion is a lithium ion.

5. A metal ion recovery device unit comprising:
a plurality of the metal ion recovery devices according to claim 1,
wherein each of the metal ion recovery devices is connected by a pipe connecting the raw solution tanks and a pipe connecting the recovery liquid tanks.

6. A metal recovery system comprising:
the metal ion recovery device according to claim 1; and
a refining device that is connected to the recovery liquid tank of the metal ion recovery device and extracts metal ions included in the metal ion recovery liquid as a compound including the metal ions.

7. A metal ion recovery method comprising:
using the metal ion recovery device according to claim 1, thereby transmitting metal ions included in the metal ion containing raw solution stored in the raw solution tank of the metal ion recovery device through the metal ion selective permeable membrane, and
recovering the metal ions with the metal ion recovery liquid stored in the recovery liquid tank.

8. A metal recovery system comprising:
the metal ion recovery device unit according to claim 5; and
a refining device that is connected to the recovery liquid tank of the metal ion recovery device unit and extracts metal ions included in the metal ion recovery liquid as a compound including the metal ions.

9. A metal ion recovery method comprising:
using the metal ion recovery device unit according to claim 5, thereby transmitting metal ions included in the metal ion containing raw solution stored in the raw solution tank of the metal ion recovery device unit through the metal ion selective permeable membrane, and
recovering the metal ions with the metal ion recovery liquid stored in the recovery liquid tank.
